(19) United States
(12) Patent Application Publication
(10) Pub. No.: US 2016/0190831 A1
(43) Pub. Date: Jun. 30, 2016

(54) VOLTAGE CONTROL METHOD FOR SECONDARY BATTERY

(71) Applicant: TOYOTA JIDOSHA KABUSHIKI KAISHA, Toyota-shi (JP)

(72) Inventors: Shinichiro MORI, Toyota-shi (JP); Junichi KIKUCHI, Anjo-shi (JP); Koji TAMARU, Toyota-shi (JP)

(73) Assignee: TOYOTA JIDOSHA KABUSHIKI KAISHA, Toyota-shi (JP)

(21) Appl. No.: 14/972,967

(22) Filed: Dec. 17, 2015

(30) Foreign Application Priority Data
Dec. 24, 2014 (JP) 2014-260953

(51) Int. Cl. H02J 7/00; B60L 11/18

(52) U.S. Cl. CPC H02J 7/0021; B60L 11/1809; H02J 7/007

(57) ABSTRACT

A voltage control method for a secondary battery includes: calculating a voltage difference between a first voltage value as an initial voltage of the secondary battery and a second voltage value as a voltage of the secondary battery after being charged by constant-current charging during a predetermined time period; calculating an internal resistance of the secondary battery based on the voltage difference and a value of constant current applied in the constant-current charging; calculating an additional voltage based on the internal resistance and a value of constant current applied during voltage control, and calculating a target voltage by adding the additional voltage to a predetermined required voltage; controlling the voltage by charging the secondary battery with constant current until the target voltage is reached; and determining that the secondary battery is defective when the target voltage is not reached within a predetermined permissible time period while the voltage is controlled.

### INCORPORATION BY REFERENCE

The disclosure of Japanese Patent Application No. 2014-260953 filed on Dec. 24, 2014 including the specification, drawings and abstract is incorporated herein by reference in its entirety.

### BACKGROUND OF THE INVENTION

1. Field of the Invention

The invention relates to voltage control methods for a secondary battery, and more particularly relates to a voltage control method for a secondary battery in which a voltage of the secondary battery after charging is controlled to a predetermined required voltage.

2. Description of Related Art

Production processes for secondary batteries include a voltage control process in which the secondary batteries are charged until the voltage of the secondary batteries reaches a required voltage. Japanese Patent Application Publication No. 2011-146372 (JP 2011-146372 A) discloses an example of such a voltage control process. According to Japanese Patent Application Publication No. 2011-146372, a plurality of buck-boost converters is provided, and the buck-boost converters supply charging voltages and discharging voltages that conform to test standards for a plurality of secondary batteries.

In the secondary batteries, a voltage relaxation phenomenon occurs after the secondary batteries are charged, due to the internal resistance of the batteries. Note that, the required voltage is a voltage of a battery pack after the voltage is controlled. It is necessary to check the voltage of the battery pack after a voltage drop due to the voltage relaxation phenomenon, in order to determine whether the voltage of the battery pack reaches the required voltage after the voltage is controlled.

However, in recent years, the number of cells of a secondary battery has been increasing and secondary batteries have been increasing in capacity. Especially in battery packs for vehicles, there are apparent trends toward an increase in the number of cells and an increase in capacity. In a large-capacity battery pack including multiple cells (hereafter, simply referred to as “large-capacity battery pack”), the amount of a voltage drop due to the voltage relaxation phenomenon is large. Therefore, there is a possibility that it will take a long time to determine whether the voltage of a large-capacity battery pack reaches the required voltage.

### SUMMARY OF THE INVENTION

The invention provides a method that reduces the time required for a test for determining whether the voltage of a large-capacity battery pack reaches a required voltage.

An aspect of the invention relates to a voltage control method for a secondary battery. The voltage control method includes: calculating a voltage difference between a first voltage value that is measured as an initial voltage of the secondary battery and a second voltage value that is measured as a voltage of the secondary battery after being charged by constant-current charging during a predetermined time period; calculating an internal resistance of the secondary battery based on the voltage difference and a value of constant current applied to the secondary battery in the constant-current charging; calculating an additional voltage based on the internal resistance and a value of constant current applied to the secondary battery during voltage control, and calculating a target voltage by adding up a predetermined required voltage and the additional voltage; controlling the voltage of the secondary battery by charging the secondary battery with constant current until the voltage of the secondary battery reaches the target voltage; and determining that the secondary battery is a defective item when the voltage of the secondary battery does not reach the target voltage within a predetermined permissible time period while the voltage of the secondary battery is controlled.

In the voltage control method for the secondary battery according to the above aspect of the invention, the target voltage after voltage control is calculated based on the pre-calculated internal resistance of the secondary battery and the amount of the constant current applied to the secondary battery during the voltage control. Therefore, the voltage of the secondary battery after a voltage drop due to a voltage relaxation phenomenon is set to the required voltage with high accuracy. Therefore, in the voltage control method according to the above aspect of the invention, it is possible to determine whether the voltage of the secondary battery reaches the required voltage based on the determination as to whether the voltage of the secondary battery reaches the target voltage at the time of the completion of the voltage control.

In the voltage control method according the above aspect of the invention, it is possible to reduce the time required for a test for determining whether the voltage of the secondary battery reaches the required voltage.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram of a charging and discharging device according to a first embodiment of the invention;

FIG. 2A is a flowchart of a voltage control process according to the first embodiment;

FIG. 2B is a flowchart of the voltage control process according to the first embodiment;

FIG. 3 is a timing chart of the voltage control process according to the first embodiment; and

FIG. 4 is a timing chart of a voltage control process according to a comparative example.

### DETAILED DESCRIPTION OF EMBODIMENTS

Hereinafter, example embodiments of the invention will be described with reference to the accompanying drawings. For the sake of clarity, omissions and simplifications will be made as appropriate in the following description and drawings. In the drawings, one and the same element will be denoted by the same reference symbol, and repetition of the detailed description thereof will be omitted as appropriate.

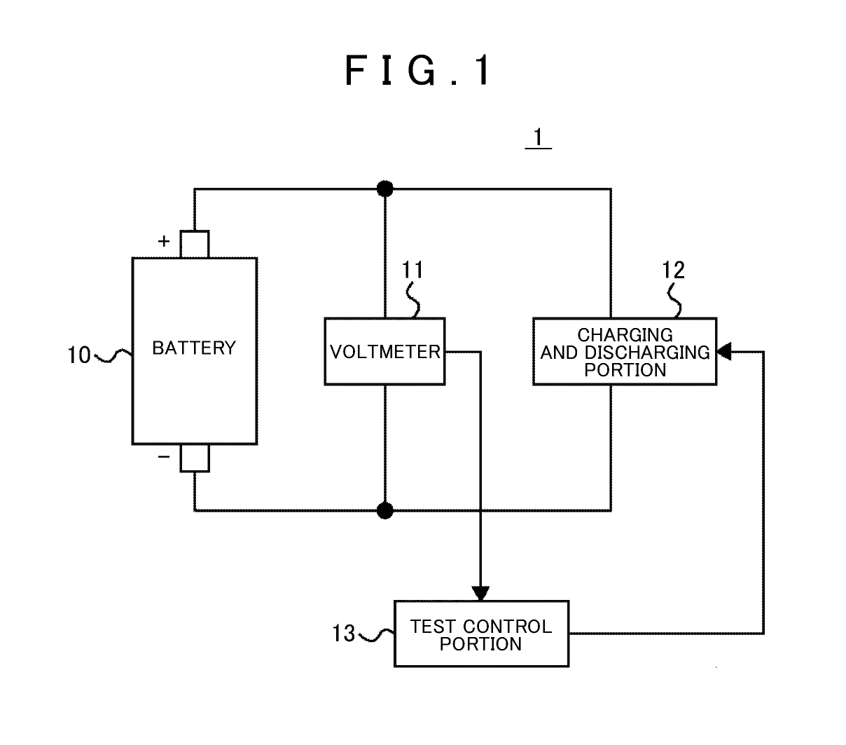

FIG. 1 is a block diagram of a charging and discharging device 1 according to a first embodiment of the invention. The charging and discharging device 1 includes a voltmeter 11, a charging and discharging portion 12, and a test control portion 13, as shown in FIG. 1. The charging and discharging device 1 performs charging and discharging of a battery 10. The battery 10 is a secondary battery. The charging and discharging device 1 charges the battery 10 with constant current.

The voltmeter 11 measures a voltage between a positive electrode of the battery 10 and a negative electrode of the battery 10. The charging and discharging portion 12 charges the battery 10 with constant current. The discharge current of the battery 10 is introduced to a predetermined discharge path by the charging and discharging portion 12. The test control portion 13 controls a period of time during which the charging and discharging portion 12 charges the battery 10 with constant current. The test control portion 13 calculates a target voltage for the battery 10, and determines whether the battery 10 is a non-defective item based on a voltage measured by the voltmeter 11.

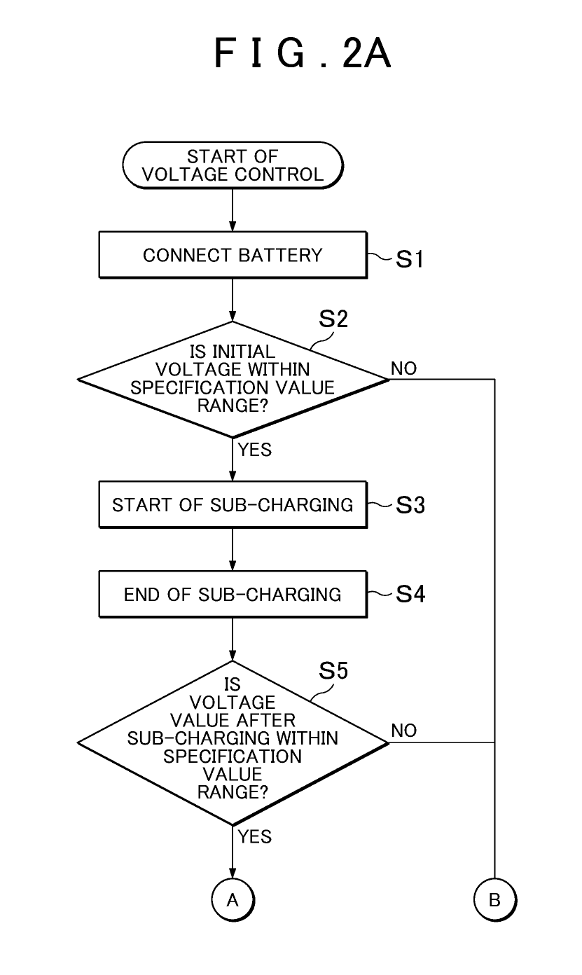

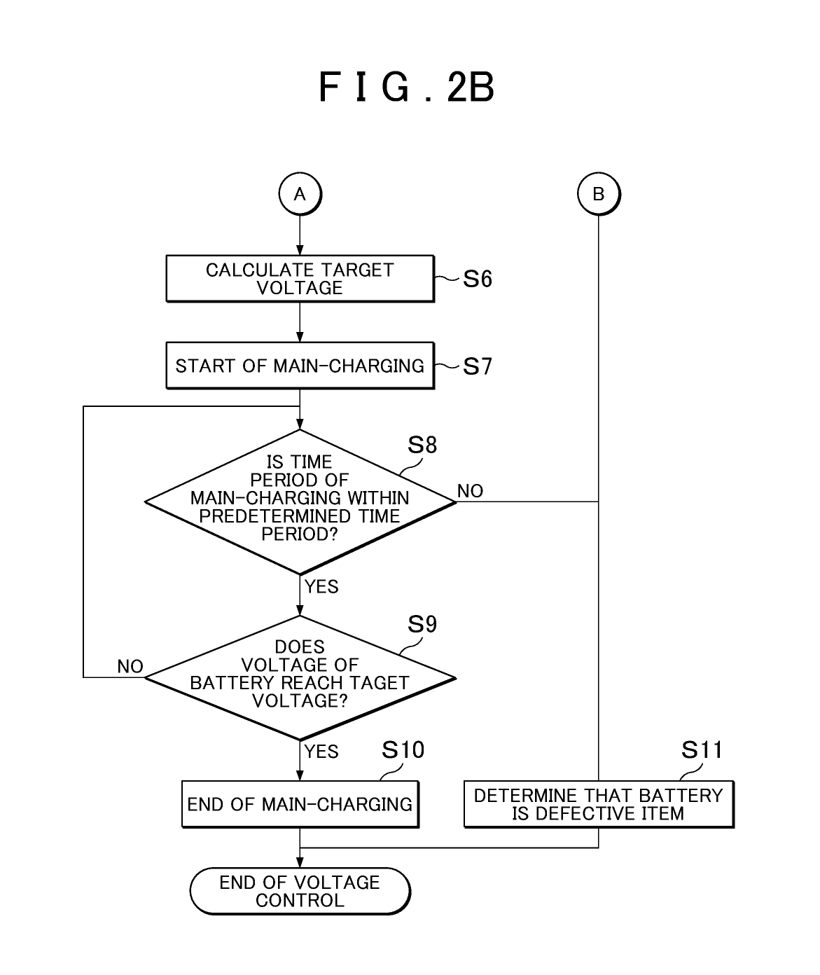

Next, a voltage control method according to the first embodiment that is performed with the use of the charging and discharging device 1 will be described. FIG. 2 is a flowchart of the voltage control method according to the first embodiment. In the voltage control method according to the first embodiment, the battery 10 is connected to the charging and discharging device 1, as shown in FIG. 2 (step S1).

Next, the charging and discharging device 1 determines whether an initial voltage of the battery 10 is within a range of predetermined specification values (hereinafter, referred to as “predetermined specification value range”) (step S2). Specifically, the charging and discharging device 1 measures a voltage of the battery 10 connected to the charging and discharging device 1, by using the voltmeter 11. The charging and discharging device 1 then determines whether the voltage of the battery 10 is within the predetermined specification value range, based on the voltage value measured with the test control portion 13. When it is determined in step S2 that the initial voltage of the battery 10 is not within the predetermined specification value range, the charging and discharging device 1 determines that the battery 10 is a defective item (step S11) and finishes the voltage control.

On the other hand, when it is determined in step S2 that the initial voltage of the battery 10 is within the specification value range, the charging and discharging device 1 starts sub-charging of the battery 10 (step S3). After the elapse of a predetermined time period, the charging and discharging device 1 terminates the sub-charging (step S4). In the sub-charging, the charging and discharging device 1 charges the battery 10 by applying constant current to the battery 10 for the predetermined time period. Then, the charging and discharging device 1 checks the voltage of the battery 10 at the time of termination of the sub-charging (step S5). When it is determined in step S5 that the voltage of the battery 10 is not within a predetermined specification value range, the charging and discharging device 1 determines that the battery 10 is a defective item (step S11) and finishes the voltage control.

On the other hand, when it is determined in step S5 that the voltage of the battery 10 is within the predetermined specification value range, the test control portion 13 calculates a target voltage (step S6). In the calculation of the target voltage, the test control portion 13 initially calculates an internal resistance of the battery 10, and then calculates the target voltage based on the internal resistance and a current value of the constant current to be applied to the battery 10 during main-charging (described later). The internal resistance R is calculated by the following equation (1), internal resistance R=ΔV1/Isub (equation (1)), where Isub represents a current value of the constant current applied to the battery 10 during the sub-charging started in step S3, and ΔV1 represents a voltage difference between the initial voltage of the battery 10 (an example of a first voltage value yin the invention) and the voltage of the battery 10 immediately after the termination of the sub-charging (an example of a second voltage value in the invention).

The target voltage can be expressed by the following equation (2), target voltage=required voltage+internal resistance R×Imain (equation (2)), where Imain represents a current value of the constant current to be applied to the battery 10 during the main-charging (described later).

Next, the charging and discharging device 1 starts the main-charging (step S7). Then, while determining whether the elapsed time after start of the main-charging (hereinafter, referred to as “main-charging time”) is equal to or shorter than a predetermined set time (step S8), the charging and discharging device 1 determines whether the voltage of the battery 10 reaches the target voltage (step S9). When the main-charging time exceeds the set time, the charging and discharging device 1 determines that the battery 10 is a defective item (step S11) and finishes the voltage control. On the other hand, the charging and discharging device 1 continues the main-charging until the voltage of the battery 10 reaches the target voltage. Then, the charging and discharging device 1 terminates the main-charging when the voltage of the battery 10 reaches the target voltage (step S10), and finishes the voltage control.

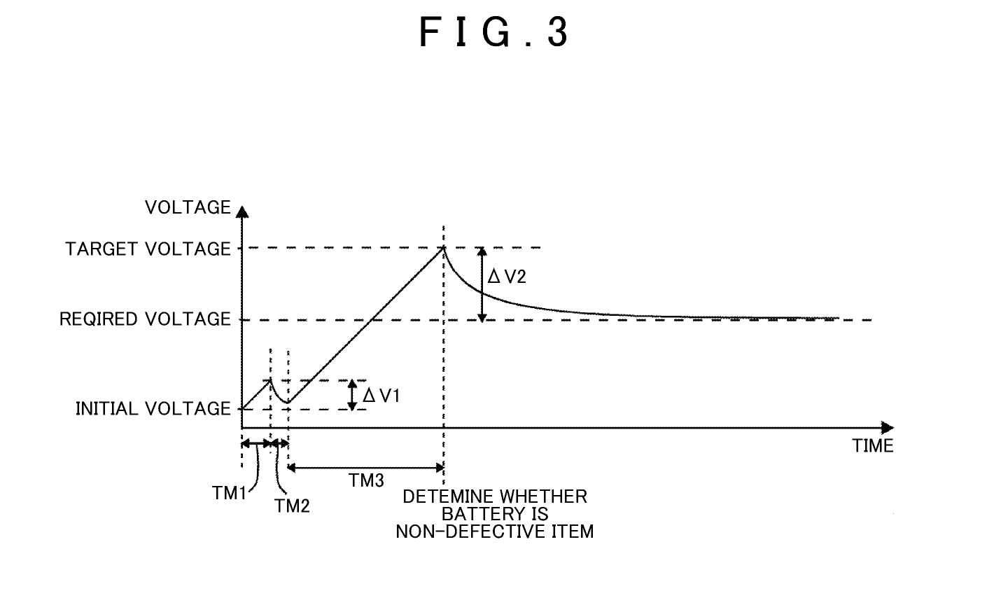

As described above, in the voltage control method according to the first embodiment, the charging and discharging device 1 calculates the internal resistance of the battery 10 based on the voltage difference in the battery 10 caused due to the sub-charging, and the test control portion 13 sets the target voltage based on the internal resistance. Thus, the test control portion 13 determines whether the battery 10 is a non-defective item based on the determination as to whether the voltage of the battery 10 reaches the target voltage due to the main-charging. In the voltage control method according to the first embodiment, after the termination of the main-charging in response to the condition in which the voltage of the battery 10 reaches the target voltage, a voltage drop due to a voltage relaxation phenomenon occurs, thereafter the voltage of the battery 10 reaches the required voltage with high accuracy. FIG. 3 is a timing chart of the voltage control method according to the first embodiment. FIG. 3 shows a voltage change of the battery 10 after the start of the sub-charging in step S3 of FIG. 2.

As shown in the FIG. 3, in the voltage control method according to the first embodiment, the charging and discharging portion 12 performs the sub-charging of the battery 10 during a sub-charging period TM1. In the sub-charging, the charging and discharging portion 12 charges the battery 10 by applying the constant current to the battery 10. Then, the test control portion 13 calculates the target voltage in a discharging period TM2. During the discharging period TM2, the battery 10 is in a state of discharging. Note that, a voltage difference ΔV1 for calculating the target voltage is a voltage difference between the initial voltage of the battery 10 at the start time of the sub-charging and the voltage of the battery 10 at the time of the termination of the sub-charging. Then, the charging and discharging device 1 calculates a voltage difference ΔV2 between the target voltage and the required voltage, based on the voltage difference ΔV1 and the current value of constant current applied to the battery 10 during the sub-charging period TM1. Then, the charging and discharging device 1 determines whether the battery 10 is a non-defective item, at the time when the voltage of the battery 10 reaches the target voltage in the main-charging time TM3. After that, the voltage of the battery 10 drops due to the voltage relaxation phenomenon, and the voltage of the battery 10 finally reaches the required voltage.

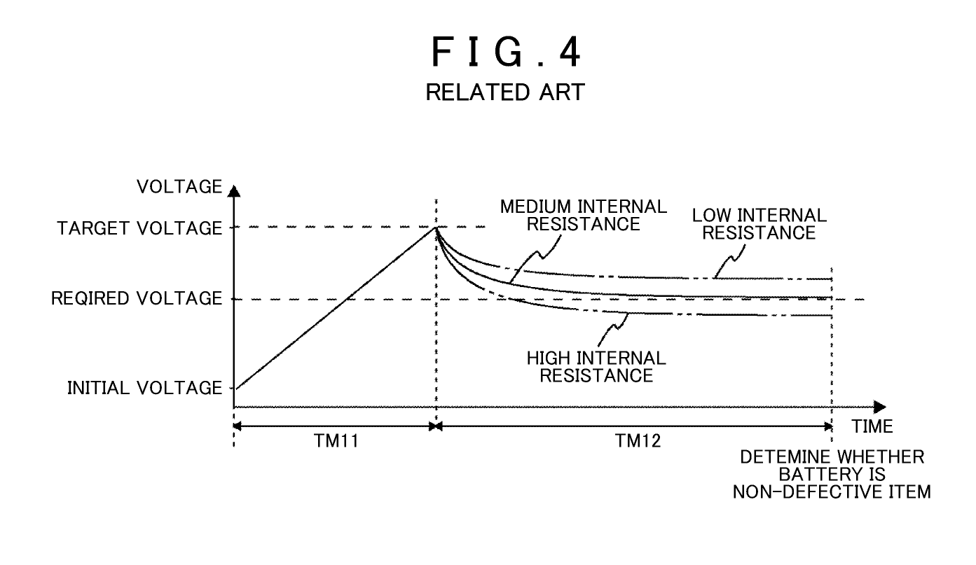

FIG. 4 shows a timing chart of a voltage control method according to a comparative example in which sub-charging and calculation of an internal resistance of the battery 10 are not performed. In the voltage control method according to the comparative example shown in FIG. 4, constant-current charging of a battery starts when the voltage of the battery is an initial voltage of the battery, and the constant-current charging is continued until the voltage of the battery reaches a target voltage set based on an estimated internal resistance (period TM11). Then, the voltage of the battery 10 drops due to the voltage relaxation phenomenon. Subsequently, it is determined whether the battery 10 is a non-defective item, at the time when the voltage of the battery 10 enters a stable state. In other words, in the voltage control method according to the comparative example, whether the battery 10 is a non-defective item is determined only after the voltage of the battery 10 enters the stable state subsequent to the voltage drop due to the voltage relaxation phenomenon. Therefore, the comparative example requires a longer test time than a test time of the voltage control method of the first embodiment.

As shown in the FIG. 4, there are variations in the internal resistance of the battery 10. In a case where the target voltage is set based on a pre-estimated internal resistance, the voltage of the battery 10 after stabilization subsequent to the voltage drop due to the voltage relaxation phenomenon may deviate from the required voltage due to variations in the actual internal resistance of the battery 10.

As described above, in the voltage control method according to the first embodiment, the charging and discharging device 1 performs sub-charging of the battery 10 in order to measure the internal resistance of the battery 10, which is a subject of the voltage control, and the test control portion 13 calculates the internal resistance of the battery 10 based on the voltage difference between the initial voltage of the battery 10 and the voltage of the battery 10 after the sub-charging. Then, the test control portion 13 calculates the target voltage suitable for the battery 10, which is the subject of the voltage control, based on the calculated internal resistance of the battery 10, and the test control portion 13 determines whether the battery 10 is a non-defective item, based on the determination as to whether the voltage of the battery 10 reaches the target voltage within the predetermined period of time.

In the voltage control method according to the first embodiment, the test control portion 13 determines whether the battery 10 is a non-defective item without the need to wait until the voltage of the battery 10 enters the stable state subsequent to the voltage drop due to the voltage relaxation phenomenon, and thus the voltage control method reduces the test time by reducing the time required for the voltage control.

In addition, in the voltage control method according to the first embodiment, the internal resistance of the battery 10, which is the subject of the voltage control, is measured, and then the target voltage suitable for the measured internal resistance is set. Therefore, the voltage of the battery 10 after stabilization subsequent to the voltage drop due to the voltage relaxation phenomenon reaches the required voltage with high accuracy. Especially, a battery pack for a vehicle is a battery assembly including multiple cells, and the capacity of each cell is large. Therefore, variations of the internal resistance are accumulated and the amount of the variations tends to increase.

In the battery pack with large variation of the internal resistance, by setting the target voltage in response to the actual internal resistance, it is possible to significantly reduce improper determinations that battery packs that should be identified as non-defective items are identified as defective items because the voltages of the batteries do not reach the required voltage.

In addition, in the voltage control method according to the first embodiment, the test control portion 13 determines whether the battery 10 is a non-defective item based on the voltage value of the battery 10 after sub-charging. Thus, it is possible to prevent main-charging from being performed on a defective battery in which the internal resistance is not within a specification value range.

The embodiments of the invention made by the present inventors have been described in detail. However the invention is not limited to the above-described embodiments and various changes and modifications may be made to the above-described embodiments within the scope of the invention.

What is claimed is:

1. A voltage control method for a secondary battery, comprising:
calculating a voltage difference between a first voltage value that is measured as an initial voltage of the secondary battery and a second voltage value that is measured as a voltage of the secondary battery after being charged by constant-current charging during a predetermined time period;
calculating an internal resistance of the secondary battery based on the voltage difference and a value of constant current applied to the secondary battery in the constant-current charging;
calculating an additional voltage based on the internal resistance and a value of constant current applied to the secondary battery during voltage control, and calculating a target voltage by adding up a predetermined required voltage and the additional voltage;
controlling the voltage of the secondary battery by charging the secondary battery with constant current until the voltage of the secondary battery reaches the target voltage; and
determining that the secondary battery is a defective item when the voltage of the secondary battery does not reach the target voltage within a predetermined permissible time period while the voltage of the secondary battery is controlled.

2. The voltage control method for the secondary battery according to claim 1, further comprising determining that the secondary battery is a defective item when the second voltage value is out of a predetermined range.

3. The voltage control method for the secondary battery according to claim 1, wherein the voltage of the battery after charging is controlled to the predetermined required voltage.

4. The voltage control method for the secondary battery according to claim 1, wherein the voltage control method is applied to a secondary battery for a vehicle, the secondary battery including a plurality of cells.
